(19) United States
(12) Patent Application Publication
(10) Pub. No.: US 2003/0209620 A1
(43) Pub. Date: Nov. 13, 2003

(54) Fishing reel with a planetary gear mechanism

(76) Inventor: Eugene Hong, Taichung City (TW)

Correspondence Address: MERCHANT & GOULD PC, P.O. BOX 2903, MINNEAPOLIS, MN, 55402-0903, US

(21) Appl. No.: 10/140,233

(22) Filed: May 7, 2002

(51) Int. Cl. A01K 89/01

(52) U.S. Cl. 242/241

(57) ABSTRACT

A fishing reel includes a planet gear mounted pivotally on a carrier and meshing with a sun gear. When a handle is actuated to rotate the carrier in a reel body, the planet gear rotates about the sun gear and relative to the carrier so that an eccentric engaging portion of the planet gear moves along an elliptical path, thereby activating a sliding member and a reciprocating shaft to reciprocate.

### BACKGROUND OF THE INVENTION

1. Field of the Invention

This invention relates to a fishing reel, and more particularly to a spinning type fishing reel that has a planetary gear mechanism.

2. Description of the Related Art

Referring to FIGS. 1 and 2, a conventional spinning type fishing reel is shown to include a body 1, a rotating member 2, a reciprocating shaft 3, a sliding member 4, a handle 5, a spool 6, a bail unit 7, and a rotating unit 8. The body 1 is hollow, and has a shoulder 101. The rotating member 2 has an integral eccentric post 201, and is rotatable about a first axis 202 within the body 1. The reciprocating shaft 3 is disposed movably within the body 1, and is movable along a second axis 301 that is perpendicular to the first axis 202. The sliding member 4 is connected fixedly to an end of the reciprocating shaft 3, and is movable on the shoulder 101 of the body 1. The post 201 of the rotating member 2 is received movably within a straight slot 401 in the sliding member 4. The handle 5 is connected to the rotating member 2 by means of a gear unit 502. When the handle 5 and the rotating member 2 rotate, the post 201 moves within the body 1 along a circular path so as to reciprocate the reciprocating shaft 3 along the second axis 301, and the rotating unit 8 and the bail unit 7 rotate about the second axis 301. As such, a fishline (not shown) can be wound around or unwound from the spool 6. The aforesaid conventional fishing reel suffers from the following disadvantages:

(1) When the fishline is wound on the spool 6, it is shaped as a tubular unit, and is formed with a plurality of turns. The reciprocating shaft 3 effects a forward travel and a reverse travel during each revolution of the rotating member 2. Because the post 201 moves within the body 1 along a circular path, the number of the turns of the fishline increases from a middle portion of the spool 6 to two end portions of the spool 6. The difference between the number of the turns formed at the two end portions of the spool 6 and that formed at the middle portion of the spool 6 is relatively large, thereby resulting in an uneven distribution of the fishline on the spool 6. Such an uneven fishline distribution will affect adversely smooth winding and unwinding operation of the fishing reel.

(2) The reciprocating shaft 3 moves between two end positions, which are spaced apart from each other by a distance that is twice the distance between the post 201 of the rotating member 2 and the first axis 202. Because the changeable range of the distance between the post 201 and the first axis 202 is relatively small due to volume constraint of the body 1, the changeable range of the distance between the end positions is reduced, thereby affecting utility of the fishing reel.

### SUMMARY OF THE INVENTION

An object of this invention is to provide a fishing reel, in which a fishline is wound on a spool so that the difference between the number of the turns of the fishline formed at a middle portion of the spool and that formed at each end portion of the spool is reduced, thereby resulting in a quite even distribution of the fishline on the spool.

Another object of this invention is to provide a fishing reel, in which the distance traveled by a reciprocating shaft during each of forward and reverse travels can be changed within a relatively large range.

According to this invention, a fishing reel includes a planet gear mounted pivotally on a carrier and meshing with a sun gear. When a handle is actuated to rotate the carrier in a reel body, the planet gear rotates about the sun gear and relative to the carrier so that an eccentric engaging portion of the planet gear moves along an elliptical path, thereby activating a sliding member and a reciprocating shaft to reciprocate. As such, a fishline can be wound on a spool so as to be shaped as a tubular unit that is formed with a plurality of turns. Because the engaging portion moves along the elliptical path, the difference between the number of the turns formed at a middle portion of the spool and that formed at each end portion of the spool is reduced, thereby resulting in a quite even distribution of the fishline on the spool. The reciprocating shaft is movable between two end positions. The distance between the end positions can be changed by varying the distance between the rotating axes of the carrier and the planet gear and/or the distance between the engaging portion and the rotating axis of the planet gear. As such, the changeable range of the distance between the end positions is increased.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a partly sectional view of a conventional spinning type fishing reel;

FIG. 2 is a fragmentary, partly sectional view of the conventional spinning type fishing reel;

FIG. 3 is a partly sectional view of a first preferred embodiment of a spinning type fishing reel according to this invention;

FIG. 4 is a fragmentary, partly sectional view of the first preferred embodiment;

FIG. 5 illustrates the distances traveled by a reciprocating shaft of the first preferred embodiment and the conventional fishing reel of FIGS. 1 and 2 when a rotating member rotates by an angle to wind a fishline on a middle portion and an end portion of a spool;

FIG. 6 is a partly sectional view of a second preferred embodiment of a spinning type fishing reel according to this invention;

FIG. 7 is a fragmentary, partly sectional view of the second preferred embodiment; and

FIG. 8 illustrates how the number of the turns of a fishline formed during each forward travel of a reciprocating shaft of the second preferred embodiment is different from that formed during each reverse travel of the reciprocating shaft.

### DETAILED DESCRIPTION OF THE PREFERRED EMBODIMENTS

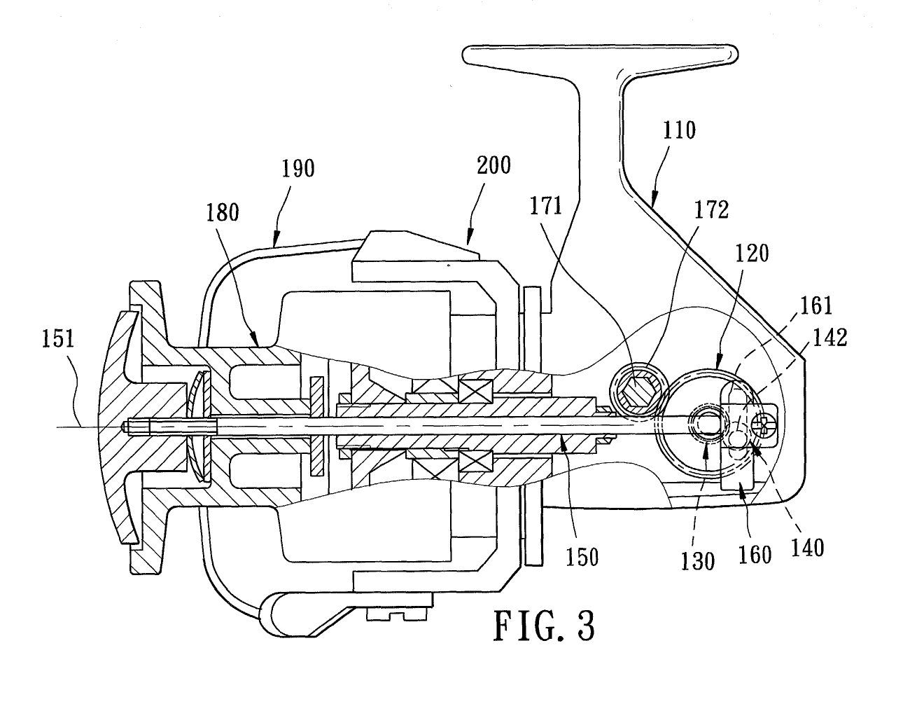

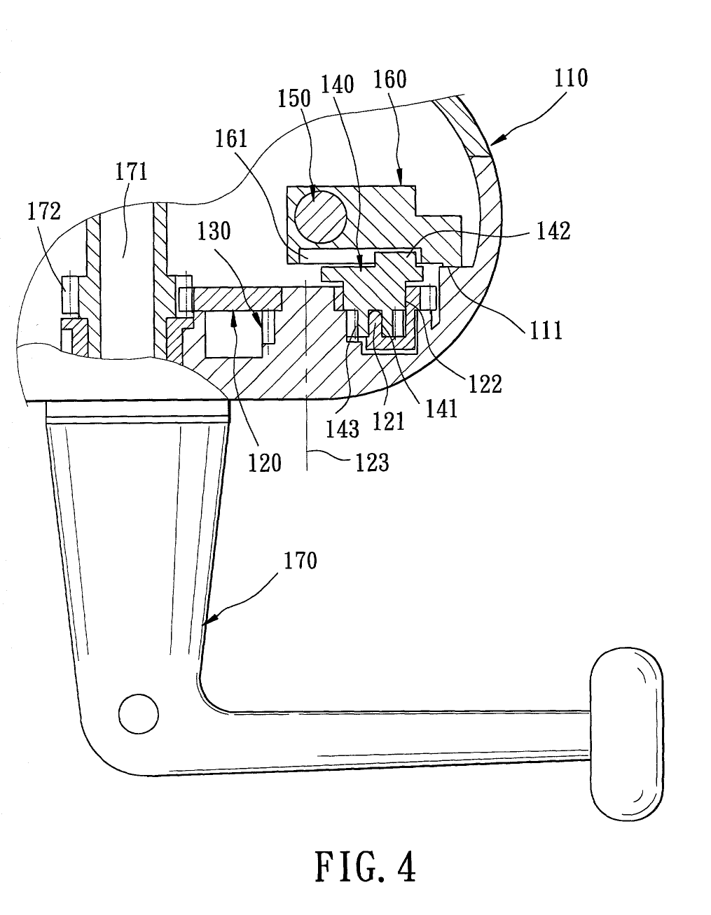

Referring to FIGS. 3 and 4, a first preferred embodiment of a spinning type fishing reel according to this invention is shown to include a reel body 110, a planetary gear mechanism consisting of a planet gear carrier or rotating member 120, a sun gear 130, and a planet gear 140, a reciprocating shaft 150, a sliding member 160, a handle 170, a spool 180, a bail unit 190, and a rotating unit 200.

The body 110 is hollow, and has an inner surface that is formed with a shoulder 111.

The sun gear 130 is disposed fixedly within the body 110.

The carrier 120 has an integral pivot portion 121 and a circular hole 122, which are coaxial, and is rotatable about a first axis 123 within the body 110.

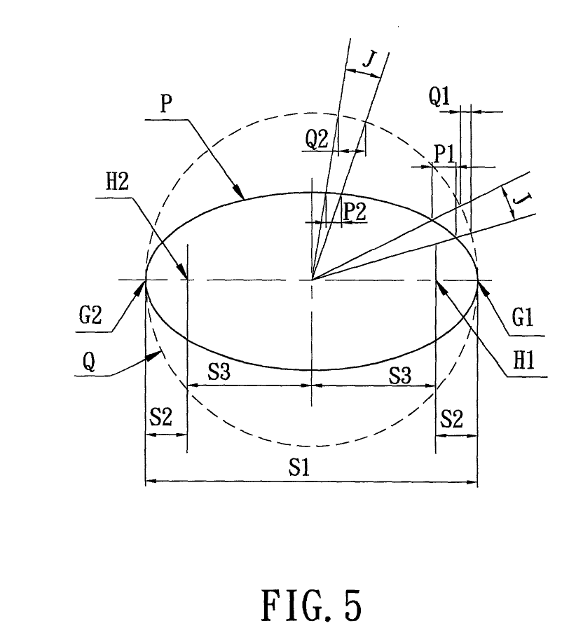

The planet gear 140 extends through the circular hole 122 in the carrier 120, and has a pivot hole 141 that engages the pivot portion 121 of the carrier 120 so as to permit rotation of the planet gear 140 about the pivot portion 121, an integral eccentric engaging portion 142, and an integral peripheral gear portion 143. As such, when the carrier 120 rotates, the planet gear 140 rotates about both the first axis 123 and the pivot portion 121 of the carrier 120 so as to move the engaging portion 142 along an elliptical path (P) (see FIG. 5).

The reciprocating shaft 150 is disposed movably within the body 110 in a known manner, and is movable between two end positions along a second axis 151 that is perpendicular to the first axis 123.

The sliding member 160 is connected fixedly to an end of the reciprocating shaft 150 in a known manner, is movable on the shoulder 111 of the body 110, and has an engaging portion 161 that is configured as a straight slot. The engaging portion 142 of the planet gear 140 is received movably within the slot 161 in the sliding member 160 so as to reciprocate the reciprocating shaft 150 along the second axis 151 when the engaging portion 142 moves along the elliptical path (P) (see FIG. 5).

The handle 170 includes a rotating shaft 171 that is journalled within the body 110, and a gear 172 that is sleeved fixedly on the rotating shaft 171 and that meshes with the gear portion 143 of the planet gear 140 so as to rotate the carrier 120 about the first axis 123 when the handle 170 is actuated.

The spool 180 is sleeved fixedly on the reciprocating shaft 150 in a known manner.

The bail unit 190 is attached to the rotating unit 200 in a known manner. The rotating unit 200 is disposed rotatably on the body 110 in a known manner. When the handle 170 is actuated, the rotating unit 200 and the bail unit 190 rotate about the second axis 151 so as to wind a fishline around the spool 180.

Referring to FIGS. 3, 4, and 5, when the engaging portion 142 of the planet gear 140 moves to a right limit point (G1) of the elliptical path (P), the reciprocating shaft 150 is disposed at a right end position. When the engaging portion 142 of the planet gear 140 moves to a left limit point (G2) of the elliptical path (P), the reciprocating shaft 150 is disposed at a left end position. As such, the reciprocating shaft 150 effects a forward travel and a reverse travel during each revolution of the carrier 120.

The fishline, which is wound on the spool 180, is shaped as a tubular unit, and is formed with a plurality of turns. When the handle 170 is actuated to rotate the carrier 120 by one unit of angle (J), the reciprocating shaft 150 moves over a distance (P1) during winding of the fishline around an end portion of the spool 180 to form a predetermined number of turns of the fishline, and over a distance (P2) which is smaller than the distance (P1), during winding of the fishline around a middle portion of the spool 180 to form the predetermined number of turns of the fishline. Accordingly, the number of turns of the fishline wound on the spool 180 reduces gradually from the middle portion of the spool 180 to two end portions of the spool 180.

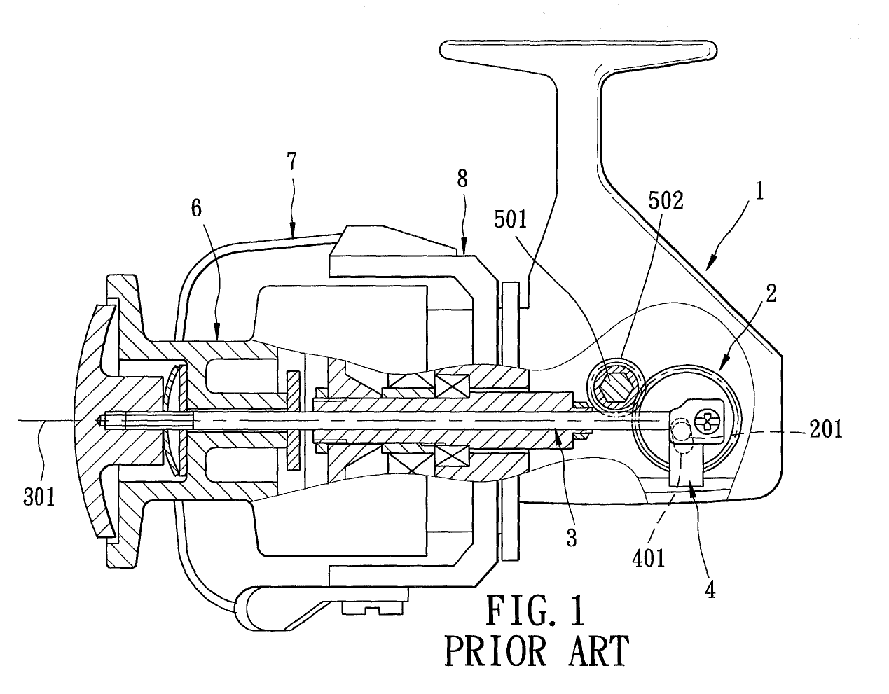

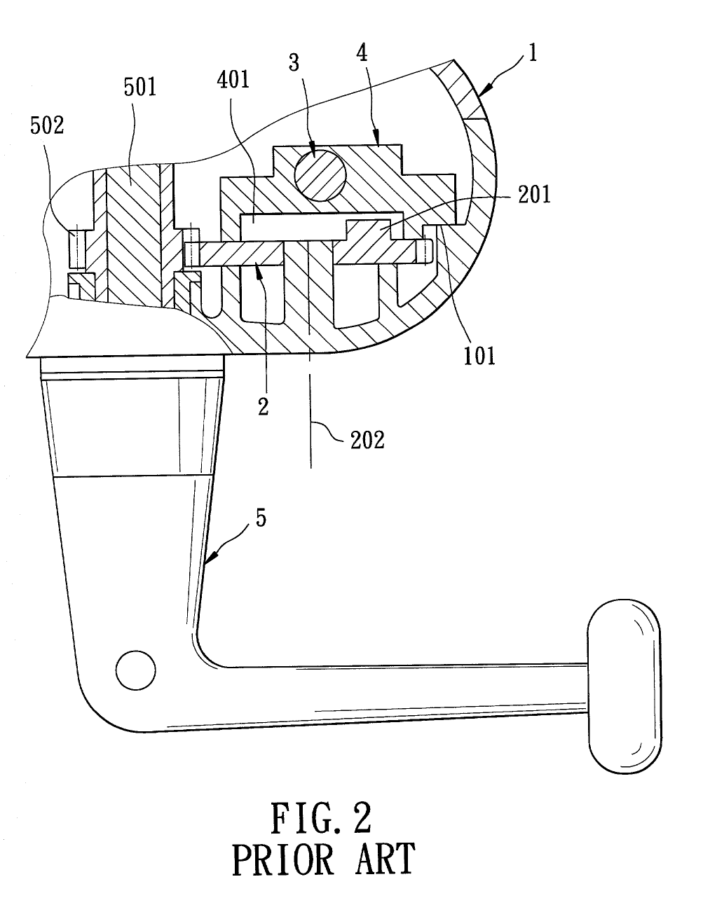

In the conventional spinning type fishing reel shown in FIGS. 1 and 2, because the post 201 (see FIGS. 1 and 2) of the rotating member 2 (see FIGS. 1 and 2) moves along a circular path (Q) shown by phantom lines in FIG. 5, when the handle 5 (see FIG. 2) is actuated to rotate the rotating member 2 (see FIGS. 1 and 2) by one unit of angle (J), the reciprocating shaft 3 (see FIGS. 1 and 2) moves over a distance (Q1) during winding of the fishline around an end portion of the spool 6 (see FIG. 1) to form the predetermined number of turns of the fishline, and over a distance (Q2), which is greater than the distance (Q1) during winding of the fishline around a middle portion of the spool 6 (see FIG. 1) to form the predetermined number of turns of the fishline. Accordingly, the number of turns of the fishline wound on the spool 6 (see FIG. 1) increases from the middle portion of the spool 6 (see FIG. 1) to the two end portions of the spool 6 (see FIG. 1). Because the difference between (P1) and (P2) is smaller than that between (Q1) and (Q2), the fishline can be distributed more evenly on the spool 180 of this invention.

The rotating axis of the planet gear 140 is movable between a right limit point (H1) and a left limit point (H2). Supposing the distance traveled by the reciprocating shaft 150 during each of the forward and reverse travels is indicated by (S1), the distance between the engaging portion 142 and the rotating axis of the planet gear 140 is indicated by (S2), and the distance between the rotating axis of the planet gear 140 and the rotating axis of the carrier 120 (i.e. the first axis 123) is indicated by (S3), the relationship among these distances can be obtained using the equation: S1=2×(S2+S3). Accordingly, the distance (S1) between the end positions can be changed by varying the distance (S2) and/or the distance (S3), thereby resulting in an increased changeable range of the distance (S1).

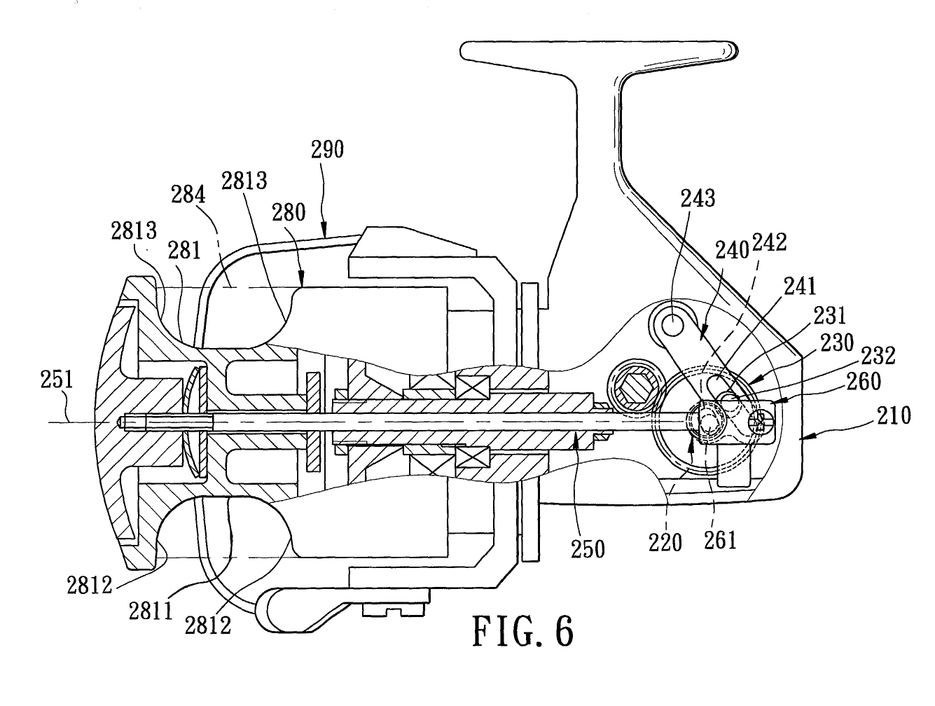

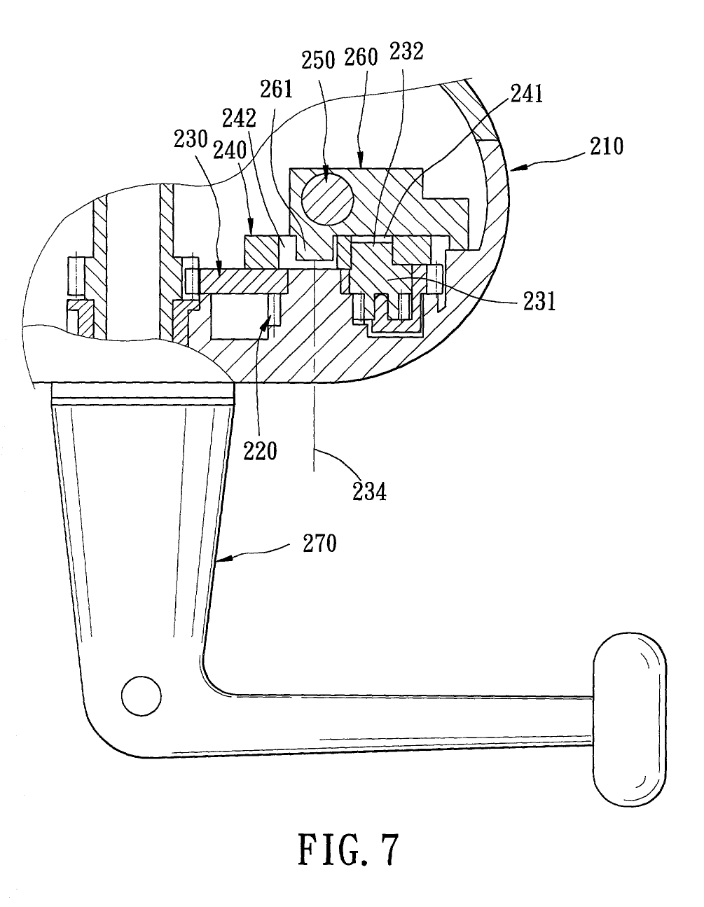

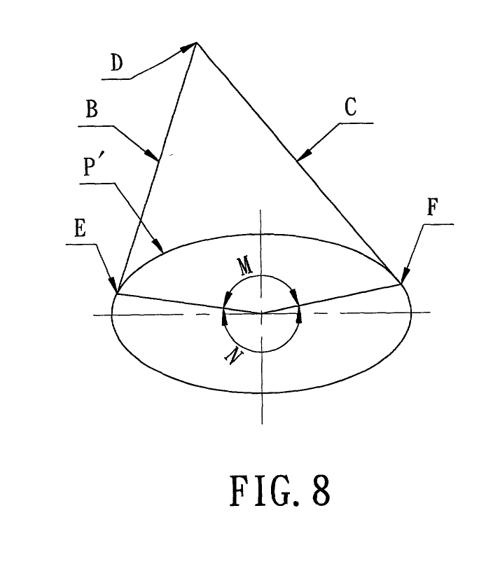

FIGS. 6 and 7 show a second preferred embodiment of this invention, which is similar to the first preferred embodiment in construction except that a planet gear 231 is connected to a sliding member 260 by means of a swing rod 240. The second embodiment includes a reel body 210, a sun gear 220, a planet gear carrier 230, a reciprocating shaft 250, a handle 270, a spool 280, and a bail unit 290. The swing rod 240 has a pair of first and second engaging portions 241, 242, and is connected rotatably to the body 210 by a pivot element 243, which has an axis (D) (see FIG. 8) that is parallel to a first axis 234, about which the carrier 230 is rotatable. The first and second engaging portions 241, 242 are configured as straight slots, which extend in radial directions of the pivot element 243 and which are angularly spaced apart from each other. The planet gear 231 has an eccentric engaging portion 232 that is configured as a post and that is received movably within the first engaging portion 241 of the swing rod 240. As such, when the carrier 230 rotates about the first axis 234, the engaging portion 232 of the planet gear 231 moves along an elliptical path (P′) (see FIG. 8) so that the swing rod 240 swings between two angular positions (B, C) (see FIG. 8).

The sliding member 260 is connected fixedly to an end of the reciprocating shaft 250, and has an engaging portion 261 that is configured as a post and that is received movably within the second engaging portion 242 of the swing rod 240 so as to reciprocate the reciprocating shaft 250 along a second axis 251 when the swing rod 240 swings between the angular positions (B, C) (see FIG. 8).

Referring to FIGS. 6, 7, and 8, when the engaging portion 232 of the planet gear 231 moves to a point (E) of the elliptical path (P′), the swing rod 240 is disposed at the left angular position (B) so that the reciprocating shaft 250 is disposed at the left end position. When the engaging portion 232 of the planet gear 231 moves to a point (F) of the elliptical path (P′), the swing rod 240 is disposed at the right angular position (C) so that the reciprocating shaft 250 is disposed at the right end position. As such, the reciprocating shaft 250 effects a forward travel and a reverse travel during each revolution of the carrier 230. When the carrier 230 rotates clockwise by a rotational angle (N) so as to move the engaging portion 232 from the point (F) to the point (E), the reciprocating shaft 250 completes a forward travel. When the carrier 230 rotates clockwise by a rotational angle (M) so as to move the engaging portion 232 from the point (E) to the point (F), the reciprocating shaft 250 completes a reverse travel. Because the number of turns of the fishline wound on the spool 280 is proportional to the rotational angle of the carrier 230, the ratio of the number of the turns of the fishline formed during each forward travel of the reciprocating shaft 250 with respect to that formed during each reverse travel of the reciprocating shaft 250 is N/M. That is to say, the number of the turns of the fishline formed during each forward travel of the reciprocating shaft 250 is different from that formed during each reverse travel of the reciprocating shaft 250, thereby further facilitating distribution of the fishline on the spool 280. When the position of the pivot element 243 is changed, the value of N/M is also changed.

The spool 280 is formed with an annular fishline-receiving groove 281 that has a uniform-depth middle portion 2811, two distal ends 2812, and two end portions 2813, each of which is disposed between the middle portion 2811 and a respective one of the distal ends 2812. Each of the end portions 2813 of the groove 281 has a depth that reduces gradually from the middle portion 2811 to the respective one of the distal ends 2812. As such, when the carrier 230 rotates by a plurality of revolutions, because the number of turns of the fishline formed at each end portion of the spool 280 is smaller than that formed at the middle portion of the spool 280, the fishline wound within the groove 281 in the spool 280 is shaped as a tubular unit 284 that has a generally uniform outer diameter.

With this invention thus explained, it is apparent that numerous modifications and variations can be made without departing from the scope and spirit of this invention. It is therefore intended that this invention be limited only as indicated by the appended claims.

I claim:

1. A fishing reel comprising:
a reel body;
a planetary gear mechanism including
a sun gear disposed within said body,
a planet gear carrier disposed rotatably within said reel body and rotatable about a first axis, said planet gear carrier having an integral pivot portion, and
a planet gear mounted pivotally on said carrier and meshing with said sun gear so as to rotate about both said pivot portion of said carrier and said first axis when said carrier rotates within said body, said planet gear having an engaging portion;
a reciprocating shaft disposed movably within said reel body and movable within said reel body along a second axis that is perpendicular to said first axis;
a sliding member connected fixedly to said reciprocating shaft and having an engaging portion that is connected to said engaging portion of said planet gear so that said reciprocating shaft reciprocates along said second axis when said planet gear rotates about said pivot portion of said carrier and said first axis; and
a handle mounted rotatably on said reel body and rotatable to rotate said carrier about said first axis so as to move said engaging portion of said planet gear along an elliptic path such that said reciprocating shaft reciprocates.

2. The fishing reel as claimed in claim 1, wherein said engaging portion of said sliding member is configured as a slot, said engaging portion of said planet gear being configured as a post that is eccentric with respect to said pivot portion of said carrier and that is received movably within said slot in said sliding member.

3. The fishing reel as claimed in claim 1, further comprising a swing rod, which is disposed swingably within said reel body and which has a first engaging portion that engages said engaging portion of said planet gear so as to swing said swing rod between two angular positions when said carrier rotates about said first axis, and a second engaging portion that engages said engaging portion of said sliding member so that said reciprocating shaft reciprocates along said second axis when said swing rod swings within said body.

4. The fishing reel as claimed in claim 3, wherein said first engaging portion of said swing rod is configured as a slot, said engaging portion of said planet gear being configured as a post that is eccentric with respect to said pivot portion of said carrier and that is received movably within said slot in said swing rod.

5. The fishing reel as claimed in claim 1, further comprising a pivot element for connecting an end of said swing rod rotatably to said body, said first and second engaging portions of said swing rod being configured as straight slots, each of which extends in a radial direction of said pivot element, said straight slots being angularly spaced apart from each other, said engaging portions of said carrier and said sliding member being configured as posts that are received respectively and movably within said straight slots in said swing rod.

6. The fishing reel as claimed in claim 1, further comprising a spool, which is sleeved fixedly on said reciprocating shaft and which is formed with an annular fishline-receiving groove that is adapted to receive a fishline and that has a uniform-depth middle portion, two distal ends, and two end portions, each of which is disposed between said middle portion and a respective one of said distal ends, each of said end portions of said groove having a depth that reduces gradually from said middle portion to the respective one of said distal ends, whereby, when said carrier rotates within said body by a plurality of revolutions, the fishline wound within said groove in said spool is shaped as a tubular unit that has a generally uniform outer diameter.
